(19) United States
(12) Patent Application Publication
(10) Pub. No.: US 2003/0075406 A1
(43) Pub. Date: Apr. 24, 2003

(54) Dynamic damper

(75) Inventor: Mick A. Nylander, Holly, MI (US)

Correspondence Address: Mick A. Nylander, GKN Automotive, Inc.,, 3300 University Drive, Auburn Hills, MI, 48326-2362, US

(73) Assignee: GKN Automotive, Inc.

(21) Appl. No.: 09/943,268

(22) Filed: Aug. 30, 2001

(51) Int. Cl. F16F 7/10

(52) U.S. Cl. 188/379

(57) ABSTRACT

A dynamic damper for absorbing vibrations in a rotary driveshaft including a mass member having an inner surface, an outer surface, and a hinge, wherein the mass member is affixable to a rotary driveshaft when the mass member is in the closed position.

### TECHNICAL FIELD

This invention relates to a dynamic damper for use with a rotary shaft. More specifically, this invention relates to a dynamic damper having a hinged mass member which is affixable in a closed position to a rotary driveshaft for use on a motor vehicle.

### BACKGROUND ART

It is known that rotary driveshafts and propeller shafts are often used in the power train designs of modem motor vehicles including automobiles. More specifically, it is known that rotary driveshafts are used to drive the front wheels of front wheel drive vehicles and propeller shafts are utilized in driving the rear drive system in rear wheel driven vehicles. In studying the rotational movement of the rotary driveshaft, it is known that certain unbalanced rotation may occur at certain rotational speeds. Undesirable vibrations may be induced into the rotary driveshaft as a result of an unbalanced rotation. These undesirable vibrations often present themselves as bending or torsional forces within the driveshaft during rotation.

It is obvious that bending or torsional forces due to the unbalanced rotation of the rotary driveshafts are not desirable or suitable in the operation of the drive train of most vehicles. It is known to utilize various dynamic dampers and mass dampers to suppress the undesirable vibrations that are induced in the rotary driveshaft due to the unbalanced rotation.

Dynamic dampers are often installed or inserted directly onto the rotary driveshafts. The dynamic damper is designated to generate a prescribed vibrational frequency adjusted to the dominant frequency of the excited harmful vibrations. The dynamic damper converts or transfers the vibrational energy of the rotary drive shaft to the dynamic damper by resonance, and eventually absorbs the vibrational energy of the rotary driveshaft. In short, the dynamic damper attempts to cancel or negate vibrations that are induced onto or caused by the rotary driveshaft in normal operation of the drive train of the vehicle.

It is understood that the ultimate design of front wheel drive rotary driveshafts often depend upon engine compartment space constraints set by the vehicle manufacturers. The eventual size and design of the dynamic damper must therefore be commensurate with the engine compartment design and other vehicle space constraints. Lastly, the dynamic damper must appropriately generate the specific harmonic frequency range that is required to counteract the undesirable vibrations of the rotary driveshaft.

In most powertrain and engine compartment designs, downsizing or reducing the size of most components, including that dynamic damper while still affording the proper horsepower or torque range is desirable. It is therefore important to have a dynamic damper which is as small in overall size as practical while still affording the correct vibrational counteracting frequency range of operation.

U.S. Pat. No. 5,056,763 to Hamada, et al. discloses a dynamic damper. The dynamic damper of Hamada, et al. comprises a pair of ring shaped fixing members spaced apart at a predetermined interval. The dynamic damper of Hamada is inserted onto and supported by the rotary driveshaft. A mass member is disposed between the pair of ring shaped fixing members. A pair of connecting members are then provided to connect the ends of the fixing members to the ends of the mass member. It is noted that the dynamic damper design of Hamada, et al. also requires individual metal clamps to be added on either side and over the ring shaped fixing members to operationally affix the dynamic damper to the rotary shaft. Further, it should be noted that the ring shaped fixing members are spaced apart from the mass member not only in a vertical but also in horizontal direction thereby increasing the overall size of the dynamic damper.

U.S. Pat. No. 5,660,256 to Gallmeyer, et al, addresses the above mentioned problems by providing a dynamic damper for absorbing vibrations in a rotary shaft. The dynamic damper comprises a mass member having an inner surface and an outer surface. A plurality of elongated connecting members extend radially inwardly from the inner surface of the mass member thereby defining a plurality of spaced apart attachment surfaces which directly contact the shaft. As disclosed, the mass member is cylindrical in shape and is of a press fit style which is directly installed around the outer circumference of a rotary driveshaft.

While the above referenced patent to Gallmeyer addresses and solves the problem of undesirable vibrations in a rotary driveshaft, the single piece press fit design requires installation at the time of assembly of the receiving drive shaft and before installation in a vehicle. In some cases, this requirement may cause additional and undesirable time and labor.

Consequently, a need has developed for an improved dynamic damper which may be installed subsequent to the assembly and installation of a receiving driveshaft.

### DISCLOSURE OF INVENTION

According to the present invention there is provided a dynamic damper for absorbing vibrations in a rotary driveshaft, the dynamic damper comprises a hinged mass member having an inner surface and an outer surface. The damper also includes a plurality of elongated connecting members extending radially inwardly from the inner surface of the mass member thereby defining a plurality of spaced apart attachment surfaces. In one embodiment of the present invention, the cylindrical mass members are affixable to the rotary driveshaft such that each of the plurality of spaced apart attachment surfaces contacts the rotary driveshaft. The mass member is also spaced apart from rotary driveshaft and is supported from the connecting members to allow the mass member to vibrate by resonance. The connecting members are thereby subjected to compression deformation between the mass member and the rotary driveshaft.

It is an object of the present invention to provide a dynamic damper which is compact in configuration while still generating upon rotation an inherent harmonic range to dampen the undesirable vibrations caused by the rotary driveshaft.

It is a further object of the present invention to provide a dynamic damper which allows for changes in the harmonic frequency range by adding or deleting a certain predetermined number of radially extending connecting members.

It is yet another object of the present invention to provide a dynamic damper which allows for changes in the harmonic frequency range of the dynamic damper through modifications in the lateral length of the connecting members.

It is yet a further object of the present invention to provide a dynamic damper wherein the rectangular connecting members are equally spaced apart from each other along the inner surface of the cylindrical mass member.

It is still a further object of the present invention to provide a dynamic damper wherein the connecting members are formed from the integral elastic material coating that covers the entire inner and outer surfaces of the cylindrical mass member.

It is yet still another object of the present invention to provide a dynamic damper wherein the mass member constitutes an insert and is molded integrally with the connecting members.

It is yet still a further object of the present invention to provide a dynamic damper which is affixable to a rotary driveshaft subsequent to assembly and installation in a vehicle.

The above objects and other objects, features, and advantages of the present invention are readily apparent from the following detailed description of the best mode for carrying out the invention when taken in connection with the accompanying drawings.

### BRIEF DESCRIPTION OF DRAWINGS

FIG. 1 is a end view of the dynamic damper of the present invention illustrating one configuration of the connecting members:

FIG. 2 is a partially segmented side view of the connecting member of the present invention;

FIG. 3 is a partially segmented side view of the hinged member of the present invention in a closed position;

FIG. 4 is a partially segmented side view of the hinged member of the present invention in a substantially open position;

FIG. 5 is a cross sectional view of the dynamic damper of the present invention taken along line 5-5;

FIG. 6 is an alternative embodiment of the present invention showing a housing affixable to the outer surface of the mass member.

FIG. 7A is a partially segmented side view of one different alternative affixing member of the present invention.

FIG. 7B is a partially segmented side view of yet another different alternative affixing member of the present invention;

FIG. 7C is a partially segmented side view of yet another different alternative affixing member of the present invention.

### BEST MODE FOR CARRYING OUT THE INVENTION

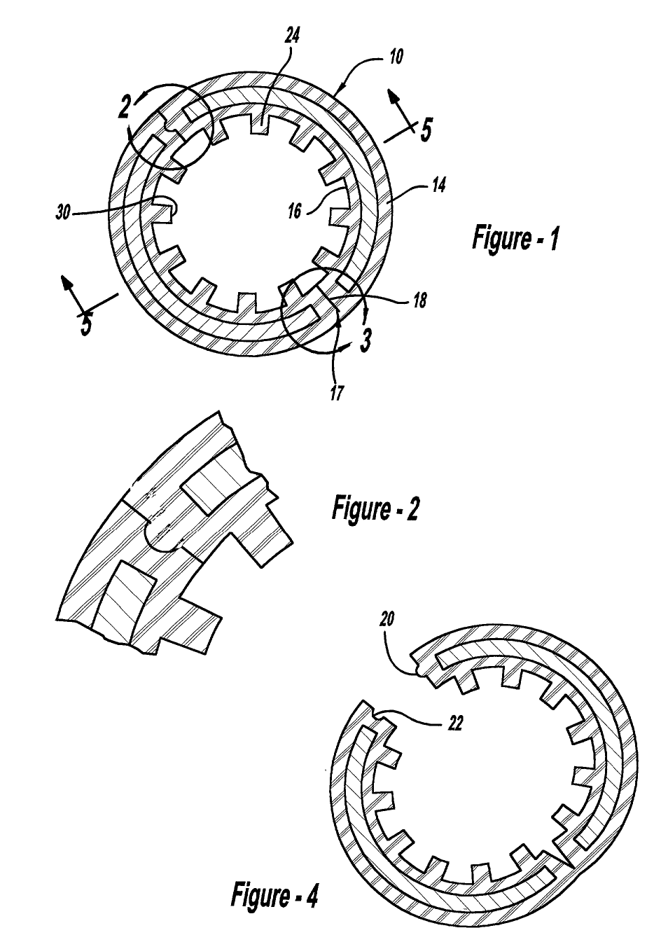

Referring to FIGS. 1 and 5 of the drawings, there is shown generally a dynamic damper 10 of the present invention. Dynamic damper 10 includes a mass member 12 having an outer surface 14 and an inner surface 16. Mass member 12 may be manufactured from various metals or alloys or other materials providing a sufficient density to provide the required vibrational frequencies to dampen the harmful vibrations of a rotary driveshaft. The mass member 12 of the preferred embodiment of the present invention is manufactured from a low carbon steel.

The dynamic damper 10 of the preferred embodiment of the present invention includes at least one hinge member 17 such as, for example, annular cut 18 in mass member 12 which provides the mass member with an open and a closed position. Mass member 12 further includes locking means 19 such as, for example mated tab 20 and receptacle 22 for removably securing the damper to a drive shaft when the mass member 12 is in the closed position. Of course, any suitable hinge and/or locking means may be utilized depending on the application, provided that the goal of permitting the damper to be installed subsequent to driveshaft assembly and installation is achieved. Such variations are, therefore, contemplated and deemed to be within the scope of the present invention.

Referring still to FIG. 1, there is shown a plurality of elongated connecting members 24. Each elongated connecting member 24 extends substantially radially inwardly from the inner surface 16 of the mass member 12 toward the central axis of rotation 26 of the rotary driveshaft 28. In the preferred embodiment of the present invention the elongated connecting members 24 are generally rectangular in shape. It is, of course, contemplated in the present invention that the elongated connecting members may be of any suitable shape depending on the application and include, without limitation, for example, frustoconical, inverted frustoconical circular or of any other shape which affords a connecting surface between the rotary driveshaft 28 and the elongated connecting members 24.

Each elongated connecting member 24 includes an attachment surface 30 which faces the central axis of rotation 28. In this manner, the mass member 12 is spaced apart from rotary driveshaft 28 when installed and is also supported by the plurality of connecting members 24 through the contact with the plurality of engaged attachment surfaces 30.

It is further contemplated in the preferred embodiment of the present invention that the elongated connecting members 24 are equidistantly spaced apart along the circumference of the inner surface of the cylindrical mass. Each elongated connecting member 24 is made from an elastomeric material which is capable of absorbing compression forces of varying amounts. It is further contemplated in the preferred embodiment of the present invention that the cylindrical mass member 12 is coated with a elastomeric material such as a rubber and that the elongated connecting members 24 are integrally connected to the coating and cylindrical mass member 12. The cylindrical mass member 12 may also be insert molded during the molding process such that the coating and connecting members are integrally connected as one contiguous piece to the cylindrical mass member 12.

The above specification is only an example of the corresponding relationship between a dynamic damper and a rotary driveshaft and many various combinations, dynamic dampers and rotary driveshafts are possible. The size of the CV joints used will also vary the size of the damper 10 and its mass member 12. It should be noted that the present invention allows for changes of the frequency range of the dynamic damper 10 note only by changes in the size and weight of the mass member 12, but also through changes in the hardness and composition in the rubber, the number of connecting members 24 that are set forth throughout the inner surface 16 of the mass member 12, the lateral length of the connecting member 24, and the width of the attachment surface 30. This allows for greater use of the dynamic damper design of the present invention in many various rotary driveshaft applications without significant changes in the manufacturing process of the dynamic damper.

In operation, when the rotary driveshaft 28 of the present invention rotates, undesirable vibrations may be created in the rotary driveshaft. The mass member 12 of a dynamic damper 10 therefore begins to resonate through the rotation of the rotary driveshaft 28. The intrinsic frequency of the mass member 12 is adjusted to the frequencies of the undesirable vibrations and the adjustment of the intrinsic frequency is performed, as discussed above.

Referring now to FIG. 6, there is shown an alternative embodiment of the present invention. A housing 32 is provided that is affixable to and envelopes the outer surface 14 of mass member 12. In the preferred embodiment shown, housing 32 encloses substantially all of outer surface 14. Again, however, it is understood that any suitable housing may be used that encloses less of surface 14. This housing 32 may comprise, for example, an annular ring, a mesh, etc. Housing 32 may also comprise any suitable material including, without limitation, metal rubber, plastic, etc.

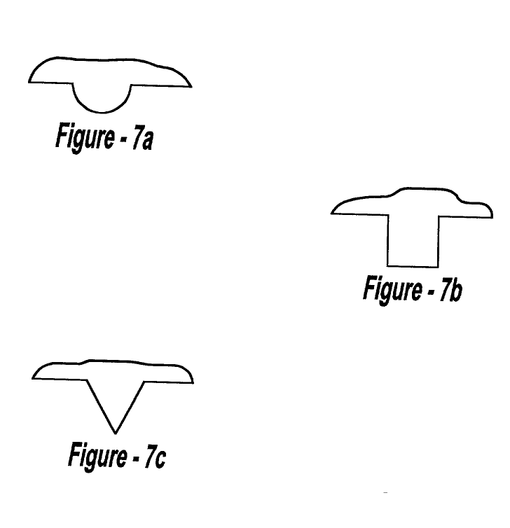

Turning now to FIGS. 7A-7C, there are shown a variety of locking means 19 including male tabs 20 which may be semicircular, rectangular, triangular, or any other suitable shape. Of course, in each case, a female receptacle having the same or other suitable shape will be required.

As shown in FIG. 1, mass member 12 is in a closed position prior to attachment to a driveshaft 28. Members 24 will, of course, become compressed by the force of drive shaft 28 when mass member 12 is installed. A preferred range from 0.25 mm to 2.0 mm of interference fit is desirable to obtain the proper fit for the damper 10 on the shaft 28. The attachment surfaces 20 directly contact and engage the rotary driveshaft 28 such that the dynamic damper 10 can be adequately connected to the rotary driveshaft without the use of clamps. This is particularly useful in manufacturing and assembly operations and provides a significant cost savings.

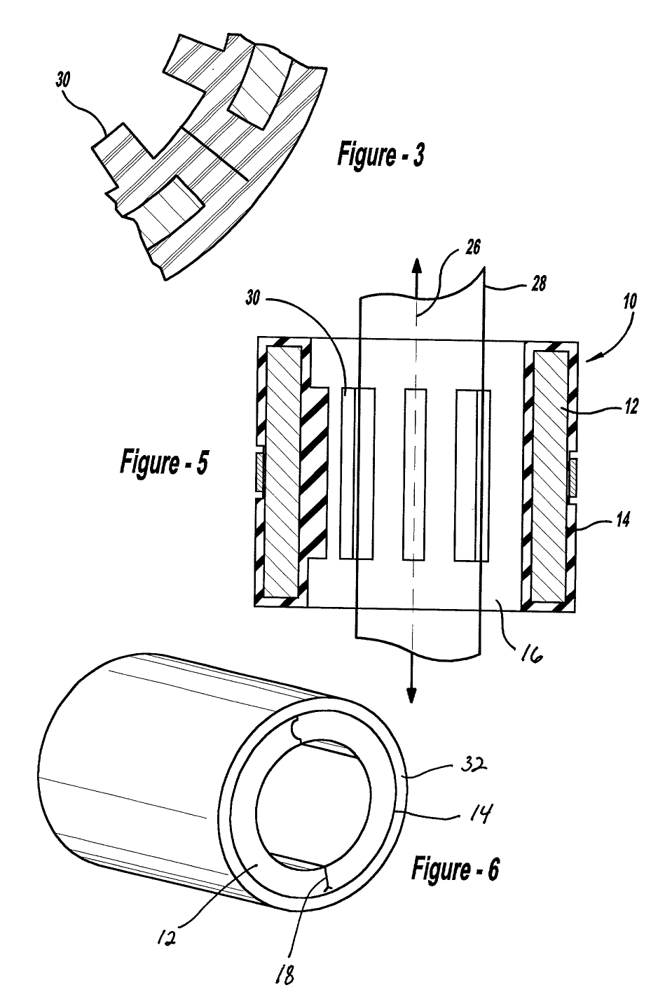

Referring to FIGS. 1-3, it is shown that the connecting members 24 are generally rectangular in shape. The connecting members 24 preferably, but not necessarily, extend along at least 25% of the inner surface of the cylindrical mass member 12.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A dynamic damper, comprising:
a mass member having an inner surface, an outer surface, and a hinge, the mass member being affixable in a closed position to a rotary shaft.

2. A dynamic damper, comprising:
a hinged mass member having an inner surface and an outer surface, the mass member being affixable in a closed position to a rotary shaft; and
a plurality of elongated connecting members each extending radially inwardly from the inner surface of the mass member toward the rotary shaft thereby defining a plurality of spaced apart attachment surfaces, wherein each of the plurality of spaced apart attachment surfaces secures the damper in the closed position to the rotary shaft, the mass member being spaced apart from the rotary shaft and being supported by the connecting members directly contacting the shaft to allow the mass member to vibrate by resonance, and the connecting members being subjected substantially to compressive deformation between the mass member and the rotary shaft.

3. A dynamic damper as in claim 2, wherein the rotary shaft has a central axis of rotation and each of the plurality of spaced apart attachment surfaces is aligned in a direction substantially parallel thereto.

4. A dynamic damper as in claim 2, wherein the connecting members are equidistantly spaced apart from each other along the inner surface of the cylindrical mass.

5. A dynamic damper as in claim 2, wherein the connecting members are formed from an elastic material.

6. A dynamic damper as in claim 5, wherein the elastic material is rubber.

7. A dynamic damper as in claim 2, wherein the mass member is insert molded integrally with the connecting members.

8. A dynamic damper as in claim 2, wherein the connecting members are generally rectangular in shape and extend along at least 25% of the inner surface of the mass member.

9. A dynamic damper as in claim 2, wherein the mass member is cylindrical in shape when in the closed position.

10. A dynamic damper as in claim 1, further comprising:
a housing affixable to the mass member when the mass member is in the closed position to further secure the mass member to the rotary shaft.

11. A dynamic damper as in claim 10, wherein the housing is substantially cylindrical in shape.

12. A dynamic damper as in claim 10, wherein the housing is formed from a metallic material.

13. A dynamic damper as in claim 10, wherein the housing is formed from a plastic material.

14. A dynamic damper as in claim 10, wherein the housing is formed from an elastic material.

15. A dynamic damper as in claim 10, wherein the housing envelopes substantially all of the outer surface of the mass member when the mass member is in the closed position.

16. A dynamic damper as in claim 10, wherein the housing is formed from a heat shrinkable material.

17. A dynamic damper as in claim 10, wherein the housing is an annular ring.

18. A dynamic damper as in claim 1, wherein the mass member further comprises locking means for removably securing the mass member to the drive shaft when the mass member is in the closed position.

19. A dynamic damper as in claim 18, wherein the locking means comprises a mated tab and receptacle.
